(19) United States
(12) Patent Application Publication
(10) Pub. No.: US 2014/0193084 A1
(43) Pub. Date: Jul. 10, 2014

(54) CONTENT VALIDATION ANALYSIS METHOD AND APPARATUS

(71) Applicant: Wireless Ronin Technologies, Inc., Minnetonka, MN (US)

(72) Inventors: Dinusha MAHINKANDA, Minnetonka, MN (US); Ben NIELSON, Minnetonka, MN (US)

(73) Assignee: Wireless Ronin Technologies, Inc., Minnetonka, MN (US)

(21) Appl. No.: 14/151,059

(22) Filed: Jan. 9, 2014

Related U.S. Application Data
(60) Provisional application No. 61/750,528, filed on Jan. 9, 2013.

(51) Int. Cl. G06K 9/62

(52) U.S. Cl. CPC G06K 9/6202
USPC 382/218

(57) ABSTRACT

A method and apparatus for verifying that information transmitted for display has been displayed. The method utilizes a plurality of algorithms to provide real-time monitoring of digital signage and displays.

### RELATED APPLICATIONS

The present application claims priority to and incorporates by reference thereto, U.S. Provisional Patent Application No. 61/750,528, filed on Jan. 9, 2013.

### BACKGROUND

1. Field of the Invention

This invention relates to an apparatus and method for validating the content of digital signage and displays. In particular, the invention relates to a method and apparatus to determine if content has been properly received, imaged, or displayed on one or more digital displays in response to such content being sent thereto.

2. Background of the Invention

Digital signage has rapidly evolved as a replacement for traditional signs and displays. In particular, traditional print/static displays, signs, advertising, and the like are being replaced at a rapid pace with signage displayed on video monitors, flat screen panel displays, touch screens, and other similar devices. The application of this technology is occurring in a wide array of industries and business sectors. For example, a wide variety of retail establishments use in-store digital signage to communicate advertising, point of sale information, pricing, and other information to their customers in real-time. Restaurants can display their menu specials on a screen and program the computer server to change the displays at specific hours; for example, corresponding to breakfast, lunch, and dinner services. These types of displays are now common at restaurants, grocery stores, banks, department stores, convenience stores, and shopping malls.

Digital signage is penetrating transportation hubs like train stations, subways, airports, rail lines, bus stations, highways, and other transportation settings around the world. The information available to travelers on such displays greatly simplifies the travel experience. Arrival and departure times, as well as announcements and messages, can be sent to specific gate locations, and updated frequently as needed. In case of delays or other changes, digital signage solutions have proven to be an important asset in reducing travel times and relieving the frustration of long waits and delays. Tourist information centers can display maps and directions with interactive kiosks.

The hospitality industry also relies heavily in digital signage. Digital displays are commonly used in hotels, resorts, cruise ships, night clubs/bars, where they are used to broadcast targeted messages and advertisements to clients, members and guests. Interactive kiosks offer services such as directions and reservations, amenities, and convention and meeting schedules. Hotels can display schedules and locations of business meetings, upcoming event venues, and room vacancies, updated for each location by the hour.

Digital signage is now common within the financial services industry as bank products and service programs can be demonstrated visually via digital screens including interactive kiosk technology and in-store broadcast networks. Financial institutions can further brand themselves as sources of information as consumers navigate their way through the challenging decisions of money management.

Digital Signage provides powerful and flexible communication method for schools, museums, and other educational institutions. Hospitals, clinics, doctors, dentists, and veterinarians offices all have effectively leverages digital signage for presenting preventative health programming, patient education, and advertising products and services. in the corporate environment, digital signage is used to communicate with employees, customers, and vendors. Also, entertainment venues such as cinemas, sports arenas, and amusement parks use digital displays to show previews, show times, food and beverage information, broadcast game scores and highlights, advertising, and the like.

The effectiveness of digital signage depends directly on the ability of the displays to reliably and effectively deliver content, which is not an easy accomplishment. The content can come in a number of forms, including, static text, text crawls, still photos, graphics, flash files, prerecorded video, or streaming live video. In many cases, the content can comprise some combination of the foregoing. For example, a portion of the screen can display video, while another portion displays crawling text like a stock feed, sports scores, weather, or news headlines. The screen can be divided into several passive or active displays areas. The content can be delivered from one or more different content sources, including, a DVD player, usb drive, media or file server, or from web, or some combination of the above.

Delivering such varied content from so many varied sources is a technically complicated task. An even more difficult task is to determine if the content has been delivered and is properly displaying. Prior art methods merely determine if the content was sent, at least the portions of the content that a sender has control over, which ignores whether the sent content was actually delivered or properly displayed. For example, a digital signage content provider may provide content to one or more displays from a server under its control. They can determine if the server sends the content, but that does not guarantee that it was received or displayed. This method is clearly inadequate because it ignores the most common problems in rendering content, and cannot determine if content from multiple sources (not all of which are under common control) has been received and properly displayed. As a result, prior art systems merely rely on the customer to alert them of a problem after the problem has occurred, which is clearly dissatisfactory.

Even if there were a method of validating a display at the source there is still the problem of determining amongst all the different types of content that can be displayed, if the proper content is displayed and/or displayed in the proper area. For instance, a display can be divided into several regions all of which display a different type of content from a different source. This makes validation extremely difficult.

Accordingly, a need exists for an improved method and apparatus for validating the delivery and display of content to digital displays.

### DETAILED DESCRIPTION OF THE PREFERRED EMBODIMENTS

The present invention implements a variety of algorithms for the purpose of validating at the point of display the contents of a digital signage. The invention monitors the output of the display, at the point of display, in one or more manners. In particular, screen shots of the display can be captured, a camera pointed at the display can be used, and other similar means to capture the actual display. This information can then be used to validate the display to determine if the content intended for display is in fact being properly displayed.

The processing of the screen display information for validation purposes can be done at the site of display, or remotely by communicating display information to an off-site server or computing device.

One or more of the following algorithms can be used, which should take into consideration the nature of the display. The display can include a number of variations. The screen display may consist of active display, which is rapidly changing, such as video or rapidly changing photographic images. The screen display might also consist of static display, such as a single fixed image like an advertisement, which remains on display indefinitely. The screen can also display something in between, or a combination thereof. For example, a stock ticker would have both an active and static portion. The top of the display might include fixed text, with a continuous scroll of stock quotes below the text. This can also occur with a weather report, news reports, or other similar items. Also, a single display can have active, static, and mixed areas on a single display. For instance, the screen could be divided into a portion that shows a video loop, another area that displays news headlines, and a third portion that displays fixed text advertising. This complicates algorithm selection; however, this problem can be at effectively remedied by virtue of the fact that the general structure of the type of display, or portions of display per screen area, is usually known in advance.

One algorithm that can be used, preferably with static display, is to compare an image from a screen display to another image taken after a predetermined interval of time and compare the two images for a predetermined level of matching. In the case of static display, such as fixed text, or a static image, where the display does not change at all, it would be expected that the two images should be identical. Thus, the matching threshold would be very high, and if the images did not match this would be evidence of a problem with the display. The images could be compared over a 5 minute interval, and the matching threshold could be 95% or higher. Of course, these parameters (as well as others described herein) can and will vary without departing from the intended scope of the invention.

A similar algorithm could be used with mixed active and static displays, such as news tickers, stock tickers, weather forecasts, and the like. In this case, the matching threshold could be lowered to take into account that some portion of the display would be changing and some would be not. The threshold would be tailored based on advance knowledge of the ratio of static to active display. If the display is 15% active and 85% static, two display captures could be compared with a matching threshold of between 80% and 85% for example. Additionally, separate algorithms can be used independently on the active and static portions of the display, wherein the static portion of the display is analyzed against a high threshold that anticipates that under normal circumstance the display region would not change very much. The active portion of the display would be analyzed as described below. The method would work well when the active and static potions of the display are segregated into fixed regions of the display, for example if the display shows a video in one portion and a weather report in another.

For active displays, where continuous change is expected, this algorithm would not be expected to work. An algorithm that does the opposite would be better suited. In particular, two relatively contemporaneous screen images could be compared looking for no similarities, or very few similarities. The threshold could be close to 0%. If the images are more similar than the very low threshold this could indicate that the feed is stuck, or that the feed has been disconnected or interrupted for some reason. Another algorithm that could be used in this instance is to review any image for areas of constant color. If more than a certain percentage of the screen displayed, white, black, or some uniform color this could indicate an interrupted feed.

In a situation where the display is comprised of both active and static display, the algorithms can be appropriately mixed to find problems at the point of display. In some cases, the active and static regions of the display may be known in advance based on the knowledge of the entity that maintains the display and/or manages the feeds to the displays. In other cases, this information would not be known and a method of detecting the screen segments needs to be implemented.

If, for example, a camera pointed at the display (or displays) is used, embedded non-visible spectrum markers can be used to allow for the detection of the boundary of the displays and/or of regions of active and static display within a display. Another approach would be to use machine learning algorithms to parse display regions, which are methods of analysis that take as input empirical data, such as from sensors or databases, and yield patterns or predictions thought to be features of the underlying mechanism that generated the data. Machine learning algorithms can recognize complex patterns and make intelligent decisions based on input data, such as in the instance of the present invention.

In generally, the present invention can perform verification algorithms against three sources of content or failure mechanisms. First, in the case of pre-rendered content, since it is known in advance what the content is suppose to look like, the actual display can be compared to what is expected. If there were even a low level of deviation, this would indicate a problem.

Second, verification could be performed against know common failure patterns. These would include a black screen, which might indicate a simply failure to turn on or plug in the display monitor. A white screen or other similar common failure patterns could be used as well.

Third, the present display can be compared against historic content of prior displays. In this case, the historic content would be expected to be the same or very little difference would be expected.

In terms of the details of the specific methods of detecting differences in display images, four possible approaches can be used. In first approach, an exhaustive mapping can be used to compare two images for verification purposes. This consists essentially of a pixel-by-pixel mapping which would return a value indicating the number of pixels that match and/or do not match. This approach is effective, but expensive in terms of the amount of computing time required and in terms of bandwidth needed to transmit verification images.

The second approach involves traversing the image to look for black pixels on the source or original image, and then determine if these same pixels (or some percentage thereof) are black in the current display. If this were the case, then the verification would either fail, in the case of a static display, or succeed in the case of an active display. In other words, in the case of active display it would not be expected that black pixels would occur in the same spot with a very high frequency. The opposite would be true for static display regions.

The third approach would be to use a matching algorithm such as the Levenshtein distance method, which is a metric for measuring the difference between two sequences of data or information.

Another approach would be to use a block counting method that focuses on edge detection. In the case of various display areas within a single display, they typically have well defined edges, which are areas of high change. For example, the colors may change dramatically and consistently at the edge. Detection would focus on looking for changes at the edges as a measure of validation, with the expectation that change should be occurring at a high rate.

A validation decision can then be made based on the results from one or more of the methods described above. Each method returns a value that then can be measured against a predefined threshold, or the results can be combined and/or weighted to create a composite result that is then compared against a threshold value. The exact metrics can be determined over time and based on the nature of the display, whether it is static, active, or some combination thereof. It is anticipated that some experimentation will be required to determine the optimum settings and algorithm schemes.

The present invention has enormous advantages, and substantially overcomes the limitations and problems of the prior art. Prior art methods largely consist of verification that a signal has been sent, without any idea of whether it has been received, or even less desirable merely waiting for someone to report a problem with the display. In the case of verifying whether a signal has been sent, in many cases this is not possible. For instance, if the display consists of information sent from a server, then verification that the information was sent is possible from the server end. However, the information can come from multiple sources, with some information coming from a server under the control of the entity doing verification and over information coming from other sources outside the entity's control like a local video feed, or information from local network or internet connection. It would be impossible for the entity doing the verification to determine if this information was sent, let alone received. Other limitations of the prior art have been described herein.

The present invention overcomes these problems by providing real-time monitoring and verification at the display end of the system, and does not rely simply on the assumption that if information is sent it will be received or rely on someone to inform the sender of a problem. Furthermore, the various algorithms take advantage of the nature of the display (static versus active, for example) to best detect select the amount of information that needs to be transmitted from the display site to the verification site. This prevents overloading bandwidth with unnecessary information. These and other advantages will be apparent to those of ordinary skill in the art.

While the preferred embodiment of the invention has been described in reference to the Figures, the invention is not so limited. Also, the method and apparatus of the present invention is not necessarily limited to digital signage, but can be applied to any field where real-time content verification is desired.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A method and apparatus for content validation analysis, comprising:
monitoring content on a display device at a first point in time;
determining if the content displayed is valid using a validation algorithm.

2. The method of claim 1 further comprising the step of monitoring content on a display at a second point in time and wherein the validation algorithm compares the first display to the second to determine if a predetermined matching threshold is met.

3. The method of claim 2 wherein the content is substantially static and the threshold is high.

4. The method of claim 2 wherein the content is substantially dynamic and the threshold is low.

5. The method of claim 2 wherein the content is static and dynamic and the threshold is moderate.

6. The method of claim 2 wherein the content is static and dynamic within predetermined regions and a high threshold is used for the static content and a low threshold is used for the dynamic content.

7. The method of claim 2 wherein the content is static and dynamic and the threshold is proportional thereto.

8. The method of claim 1 wherein the monitoring is done by screen capture.

9. The method of claim 1 wherein the monitoring is done by a camera.

10. The method of claim 9 wherein embedded visible spectrum markers are used to detect boundaries between display areas.

11. The method of claim 1 wherein the display is comprised of various regions and machine learning algorithms validate based on predictions or pattern analysis.

12. The method of claim 1 wherein the content is pre-rendered content and validation compares the actual display to an expected display.

13. The method of claim 1 wherein the verification is based on known failure patterns.

14. The method of claim 13 wherein the known failure pattern comprises detecting a black screen.

15. The method of claim 1 wherein validation is based on a comparison of the actual display to a historic display.

16. The method of claim 2 wherein validation uses pixel-by-pixel mapping and returns a number of matching pixels in relation to a total number of pixels.

17. The method of claim 2 wherein validation is based on a comparison of a sampling of pixels of a predetermined color between the first and second display.

18. The method of claim 17 wherein the color is black.

19. The method of claim 1 wherein validation uses a Levenshtein distance method.

20. The method of claim 1 wherein validation uses a block counting method to detect edges.
